(19) United States
(12) Patent Application Publication
(10) Pub. No.: US 2010/0121721 A1
(43) Pub. Date: May 13, 2010

(54) PREMIUM BIDDING OF ONLINE ADVERTISEMENTS

(75) Inventors: Andrew Feng, Cupertino, CA (US); Guy Yalif, Burlingame, CA (US); David Allan Caswell, Los Angeles, CA (US); Dirk Reinshagen, San Mateo, CA (US); Gajendra Nishad Kamat, Bangalore (IN); Rohit Chandra, Los Altos, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/269,694

(22) Filed: Nov. 12, 2008

(51) Int. Cl. G06Q 30/00; G06Q 40/00; G06Q 90/00

(52) U.S. Cl. 705/14.73; 705/37

(57) ABSTRACT

The subject matter disclosed herein relates to utilizing one or more premium rules to associate a premium markup to a base bid for online advertising.

### BACKGROUND

1. Field

The subject matter disclosed herein relates to data processing, and more particularly to methods and apparatuses that utilize one or more premium rules to associate a premium markup to a base bid for online advertising.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. With so much information being available, advertising on the Internet often allows advertisers to target audiences viewing their advertisements. Use of the Internet for online advertising facilitates a two way flow of information between end users and advertisers. For example, an end user may request an ad and in doing so may provide information in the form of data that describes the end user in some manner. Conversely, traditional print and “hard copy” advertising may constitute a one-way flow of information from advertisers to end users.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a flow diagram showing a process for publishing of online advertising in accordance with one or more embodiments.

FIG. 2 is a diagram illustrating a hierarchical node structure for online advertising in accordance with one or more embodiments.

FIG. 3 is a diagram illustrating a premium rule hierarchical target node structure in accordance with one or more embodiments.

FIG. 4 is a diagram illustrating a premium rule hierarchical target node structure in accordance with one or more embodiments.

FIG. 5 is a flow diagram illustrating a process for utilizing one or more premium rules to associate a premium markup to a base bid for online advertising in accordance with one or more embodiments.

FIG. 6 is a block diagram illustrating an exemplary embodiment of a computing environment system in accordance with one or more embodiments.

FIG. 7 is a diagram illustrating premium rules associated with a hierarchical node structure for online advertising in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some exemplary methods and systems are described herein that may be used to determine premium bidding of online advertisements. As used herein the phrase “online advertisements,” “advertising,” and/or the like may refer to pop-up ads, banner ads, and/or the like. Such online advertisements may be described below as an ad unit. Such an ad unit may include a keyword term and a creative component. For example, such an ad unit may include text, graphic or video data (herein referred to as “creative component”). Additionally, metadata associated with a banner ad (and/or other like creative components) may include one or more keyword terms associated with the ad unit. Such ad units may be delivered to an end user based at least in part on one or more forms of online marketing processes, such as on contextual advertising, search advertising, search engine marketing, sponsored listings, and/or the like, and/or combinations thereof, for example. As will be described in greater detail below, certain exemplary embodiments described herein may provide mechanisms for advertisers (and/or other like entities) to control how certain ads may be targeted online to publishers, pages and/or end users. Similarly, certain exemplary embodiments described herein may provide mechanisms for advertisers to control additional premium markups associated with a targeting of certain publishers, pages and/or end users.

Such methods and systems that may be used to determine premium bidding of online advertisements, as described herein, may be utilized to provide a flexible and structured mechanism for advertisers (and/or other like entities) to control premium markups associated with a targeting of certain publishers, pages and/or end users. For example, such methods and system may allow for a flexible and extensive taxonomy for target dimensions to include various combinations of the following: an end user demographic, end user location, time, end user interests, publication content, publication Uniform Resource Locator (URL), publication domain, publication site, and/or the like, and/or combinations thereof. For example, in some embodiments, premium rules may be formed as decision trees associated with a single target dimension (referred to herein as basic premium rules) and/or as decision trees associated with two or more target dimensions (referred to herein as composite premium rules). Additionally, such methods and system may provide a conflict resolution between various premium rules. For example, a group of two or more premium rules may be forbidden from reusing identical target dimension sets. Further, a hierarchical target node structure may include one or more target nodes associated with a first target dimension and one or more nodes associated with a second target dimension. In such a case, such a first and second target dimensions may be restrained so that a comparison of a current context to such two or more target dimensions may match no more than one target node associated with a first target dimension and no more than one target node associated with a second target dimension.

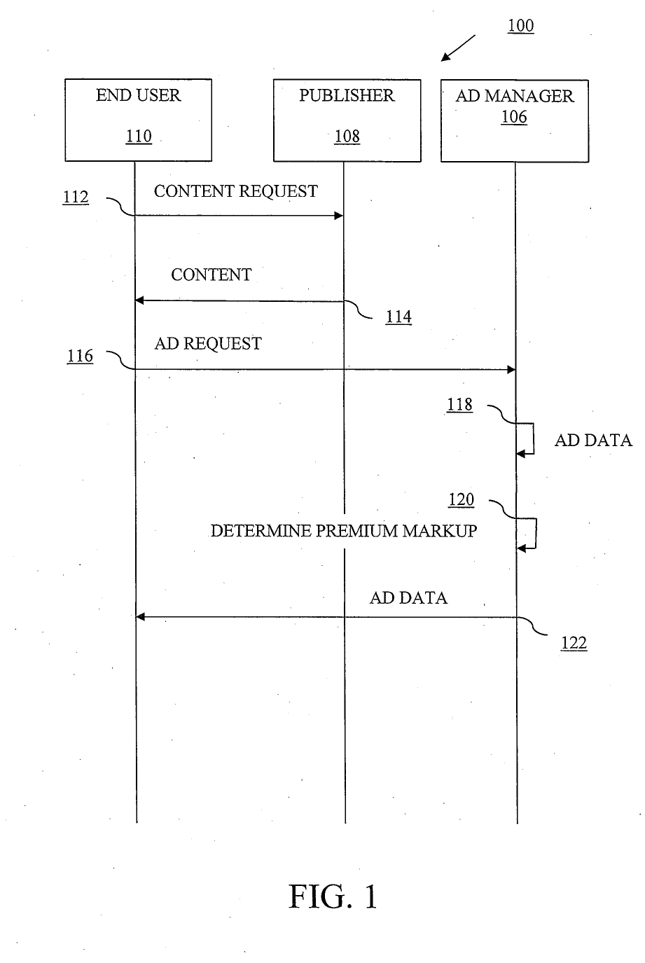

Referring to FIG. 1, a flow diagram illustrates a process for publishing of online advertising in accordance with one or more embodiments. FIG. 1 depicts a process 100 for providing up-to-date constraint based advertising content. In process 100. Although process 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter.

Process 100 depicted in FIG. 1 may in alternative embodiments be implemented in software, hardware, and/or firmware, and may comprise discrete operations. As illustrated, an ad manager 106 may be coupled in communication with one or more publisher devices 108 associated with one or more publishers. Such publisher devices 108 may comprise general purpose computing devices having a central processing unit, memory unit, permanent storage, optical drive(s), universal serial bus port(s), audio/video output devices, network interfaces, etc. Ad manager 106 may include an ad server operative to handle requests from publisher devices 108 and transmit data to publisher devices 108.

During typical online activity, an end user 110 may request a page and/or other like data file(s) of content from publisher device 108, as illustrated at action 112. Publisher device 108 may, in turn, return a content page to the end user, where the content page may contain a link and/or the like to a request for an advertisement from ad manager 106, as illustrated at action 114. In the illustrated embodiment, ad server 112 handles requests for advertisements from end users 110, as illustrated at action 116. Such a request for advertisement may include an HTTP request for advertising content initiated by a content page provided by publisher devices 108 to end users 110. For example, a request for advertisements may contain one or more current contexts associated with a given end user including a taxonomy of user centric data and/or publisher centric data. Such user centric data may include or otherwise be associated with an end user demographic (e.g. age, gender, income, and/or the like), end user location (e.g. continent, country, state/providence, city, zip, and/or the like), time (e.g. end user time, advertiser time, coordinated universal time (UTC), and/or the like), end user interests (e.g. sports, politics, and/or the like), and/or the like, and/or combinations thereof. Such user publisher centric data may include or otherwise be associated with publication content (e.g. shopping, search, and/or the like), publication Uniform Resource Locator (URL), publication domain, publication site, and/or the like, and/or combinations thereof. For example, a request for advertisement may specify a current context including end user gender, such as male or female, and/or the like. Similarly, a request for advertisement may specify a current context including end user age, such as age in years, by birthday, and/or the like, for example. Likewise, a request for advertisement may specify a current context including end user location, such as a geographic location, address, latitude and longitude, Global Positioning System location, and/or the like, for example. Further, a request for advertisement may specify a current context including end user time, such as a time of day, time zone, and/or the like, for example. Similarly, a request for advertisement may specify a current context including coordinated universal time (UTC), such as Greenwich Mean Time (GMT), other non-location dependent time measures, and/or the like, for example. Likewise, a request for advertisement may specify a current context including publication content, such as topic areas associated with such content, key words associated with such content and/or the like, for example. Further, a request for advertisement may specify a current context including publication URL, publication domain, and/or publication site that may refer to all or a portion of a string of characters used to represent a resource available on the Internet, for example. For example, a request for advertisement may specify that the requesting content page is directed towards “sports”, located on the domain “example.com”, that the end user is a male between the ages 18 and 25, that the end user is located in California, and that the end user device's screen resolution is 800 by 600 pixels.

As used herein, the term “content page” may include any information in a digital format, of which at least a portion may be perceived in some manner (e.g., visually, audibly) by a end user if reproduced by a digital device, such as, for example, a computing platform. For one or more embodiments, a content page may comprise a web page coded in a markup language, such as, for example, HTML (hypertext markup language), and/or the like. However, the scope of claimed subject matter is not limited in this respect. Also, for one or more embodiments, the content page may comprise one or more elements. The elements in one or more embodiments may comprise text, for example, as may be displayed as part of a web page presentation. Also, for one or more embodiments, the elements may comprise a graphical object, such as, for example, a digital image. Unless specifically stated, a content page may refer to either the source code for a particular web page or the web page itself. Each web page may contain embedded references to images, audio, video, other web documents, etc. One common type of reference used to identify and locate resources on the web is a Uniform Resource Locator (URL).

In the illustrated embodiment, ad manager 106 may be operative to receive advertising data associated with one or more advertisers, as illustrated at action 118. In one embodiment, advertising data may comprise text, graphic or video data (herein referred to as “creative component”) related to a given ad unit. Such an ad unit may include a keyword term and a creative component. For example, ad manager 106 may receive metadata associated with a banner ad or other like ad including, but not limited to, one or more keyword terms associated with the ad unit. In addition, advertising data also may comprise one or more rules associated with a given ad unit. As will be described in greater detail below, such rules may formed as, or be used to form, a premium rule including one or more constraints or rules that may determine the cost of such advertising based on a determination of one or more target dimensions. By way of example but not limitation, such target dimensions may be associated with and/or include a taxonomy of user centric data and/or publisher centric data. Such user centric data may include or otherwise be associated with an end user demographic (e.g. age, gender, income, and/or the like), end user location (e.g. continent, country, state/providence, city, zip, and/or the like), time (e.g. end user time, advertiser time, coordinated universal time (UTC), and/or the like), end user interests (e.g. sports, politics, and/or the like), and/or the like, and/or combinations thereof. Such user publisher centric data may include or otherwise be associated with publication content (e.g. shopping, search, and/or the like), publication Uniform Resource Locator (URL), publication domain, publication site, and/or the like, and/or combinations thereof.

For a given request for advertisement, an associated current context may be modeled as a map of a given target dimension portion and given target value portion. Likewise, for a given premium rule, an associated target dimension may be modeled as a map of a given target dimension portion and given target value portion. Such a target dimension may identify a particular current context in the above taxonomy of a given request for advertisement. For example, such a target dimension may identify a time-type current context. Such a target value may be a computed value representing a quantification of the given target dimension of a given request for advertisement. For example, such a target value may be computed to represent a quantification of a time-type current context. For example, end user time could be represented as a number of minutes within a week, such as one for 0:01 AM Monday, sixty-one for 1:01 AM Monday, and/or the like. Such a map of a current context may be compared with target dimensions associated with one or more premium rules. Based at least in part on such a comparison, such premium rules may determine at least a portion of the cost of such advertising. As will be described in greater detail below, in some embodiments such premium rules may be formed as decision trees associated with a single target dimension (referred to herein as basic premium rules) or may be formed as decision trees associated with two or more target dimensions (referred to herein as composite premium rules).

Ad manager 106 may determine which ads to send to end users 110 based at least in part on information received from advertisers. Such ad units may be filtered and/or ranked by ad manager 106 based on one or more criteria. For example such ad units may be filtered and/or ranked based on criteria from advertiser device 104, publisher device 108, and/or based on end user data. Additionally, ad manager 106 may determine a cost of such advertising based at least in part on information received from advertisers, as illustrated at action 120. As will be described in greater detail below, such information may include premium rule related information associated with a given ad unit. Such premium rule related information may include one or more constraints or rules that may determine the cost of such advertising based on a determination of one or more target dimensions. Ad manager 106 may send a response to user requests for advertisements to end users 110, as illustrated at action 122. For example, such a response to user requests for advertisements may include an ad, and may also include an associated premium value that may be embedded within the response.

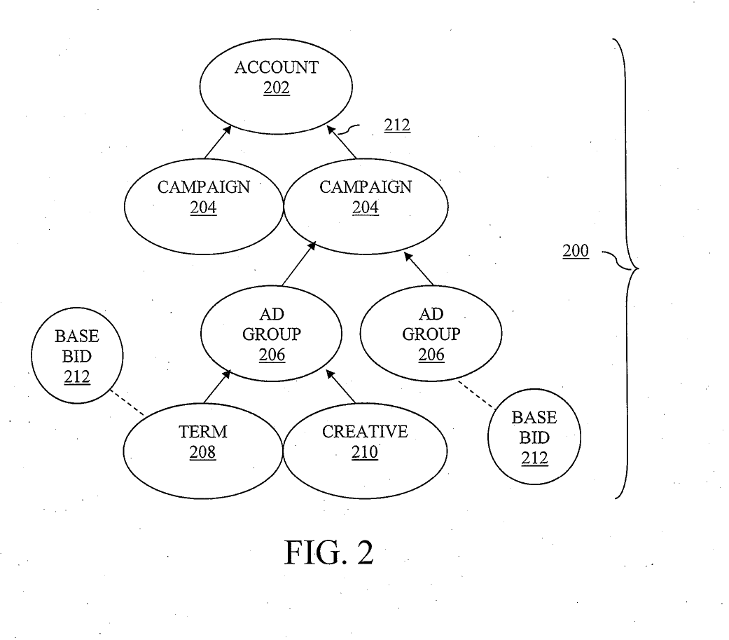

Referring to FIG. 2, a diagram illustrates a hierarchical node structure for online advertising in accordance with one or more embodiments. As discussed above, an ad manager 106 (see FIG. 1) may receive an ad data from one or more advertisers. As illustrated in FIG. 2, this ad data may be organized into a hierarchical node structure 200. For example, hierarchical node structure 200 may include any number of hierarchical nodes. Such hierarchical nodes may include account-type nodes 202, campaign-type nodes 204, ad-group-type nodes 206, keyword-term-type nodes 208, and/or creative-component-type nodes 210, and/or the like. For example, a given advertiser may organize advertising expenditures by one or more accounts that may be established with ad manager 106 (FIG. 1). Such accounts may have one or more ad campaigns that may include a series of advertisement messages that may share a common idea, goal, and/or theme. Such ad campaigns may have one or more ad units including a keyword term and a creative component. For example, a given keyword-term-type node 208 may be associated with a keyword component of an ad unit while a given creative-component-type node 210 may be associated with a creative component of such an ad unit. A given ad-group-type node 206 may be associated with a given ad unit which may belong to a given ad campaign. A given campaign-type node 204 may be associated with a given ad campaign which belong to a given account. Additionally, a given account-type node 202 may be associated with a given advertising account.

Here, hierarchical node structure 200 may express and/or represent hierarchical information within one or more computing platforms by digital electronic signals, and/or the like, for example. By way of example but not limitation, information in such a hierarchical node structure 200 may be expressed as a finite, rooted, connected, acyclic graph. Such a hierarchical ad node structure 200 may include a node (e.g., a root node) that may not have any preceding parent nodes. For example, an account-type node 202 associated with a given advertising account may be utilized as such a root node. Additionally, hierarchical node structure 200 may be traversed via edges 212 to reach a given leaf node. A leaf node may refer to a node that may not have any subsequent child nodes. For example, ad-group-type nodes 206 and/or keyword-term-type nodes 208 may be associated with a given advertising account to be utilized as a leaf node to represent a possible base bid data 212 associated with a given ad unit. Thus, a path through hierarchical node structure 200 may pass from a root node to a given leaf node. Additionally, hierarchical node structure 200 also may include interior nodes located between a root node to a given leaf node that may have a preceding parent node, such as a root node or another interior node, and also may have subsequent child nodes, such as leaf nodes or other interior nodes. For example, campaign-type nodes 204 associated with a given advertising account may be utilized as such an interior node (additional ad-group-type nodes 206, keyword-term-type nodes 208, and/or creative-component-type nodes 210 associated with individual campaign-type nodes 204 may not be illustrated here).

Such hierarchical node structures 200 may be utilized to access base bid data associated with a given item of advertising. For example, such base bid data may be utilized to sorts various ad units according to a baseline price associated with a given ad unit. Ad manager 106 (FIG. 1) may comprise a cost algorithm wherein a value of an ad may be determined based at least in part on one or more hierarchical node structures 200. For example, base bid data may be associated with a leaf node of hierarchical node structure 200, such as an ad-group-type node 206 and/or a keyword-term-type node 208. For example, base bid data may be established based on a bid associated with a keyword term that is associated with ad-group-type node 206 and/or a keyword-term-type node 208.

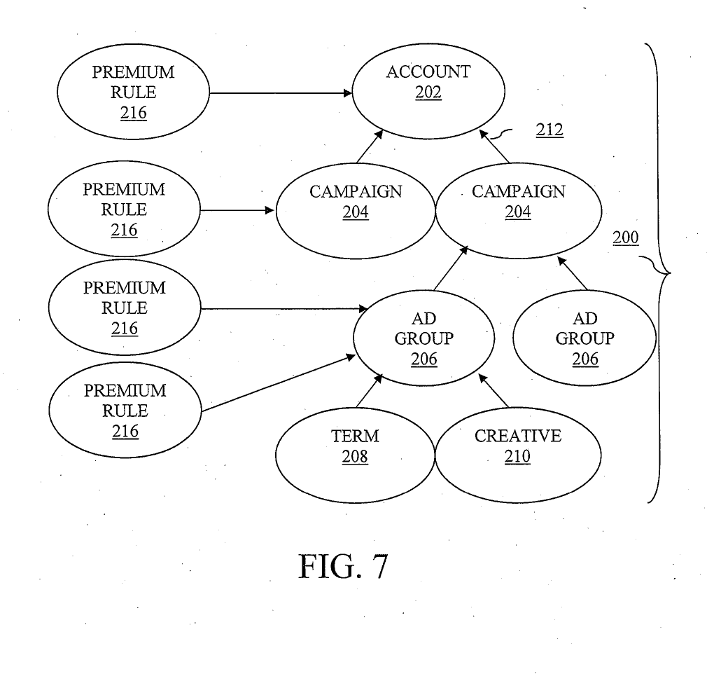

Referring to FIG. 7, a diagram illustrates premium-rules associated with a hierarchical node structure for online advertising in accordance with one or more embodiments. Individual premium rules 216 may be identified climbing up hierarchical node structure 200 from an ad-group-type node 206 and/or a keyword-term-type node 208. For example, a first type of premium rule 216 may be associated with an account 202, campaign 204, or ad-group 206, while a second different type of premium rule 216 may be associated with an account 202, campaign 204, or ad-group 206. Multiple premium rules 216 may identified by climbing up hierarchical node structure 200. Such multiple premium rules 216 may factor into the determination of premium markup data associated with a given base bid data. For example, such premium markup data may be utilized to provide a further cost that is in addition to a baseline price of base bid data associated with a given ad unit.

Additionally, one or more premium rules 216 may be associated with one or more nodes 202/204/206 of hierarchical node structure 200. Such premium rules 216 may be utilized to determine one or more premium markup values associated with a given item of advertising. Ad manager 106 (FIG. 1) may comprise a cost algorithm wherein a value of an ad may be determined based at least in part on one or more premium rules 216. For example, a premium markup value may be associated with a leaf node of hierarchical node structure 200, such as an ad-group-type node 206 and/or a keyword-term-type node 208. As will be described in greater detail below, such premium rules 216 may include a hierarchical target node structure associated with two or more target dimensions for use in determining a premium markup for a given item of advertising.

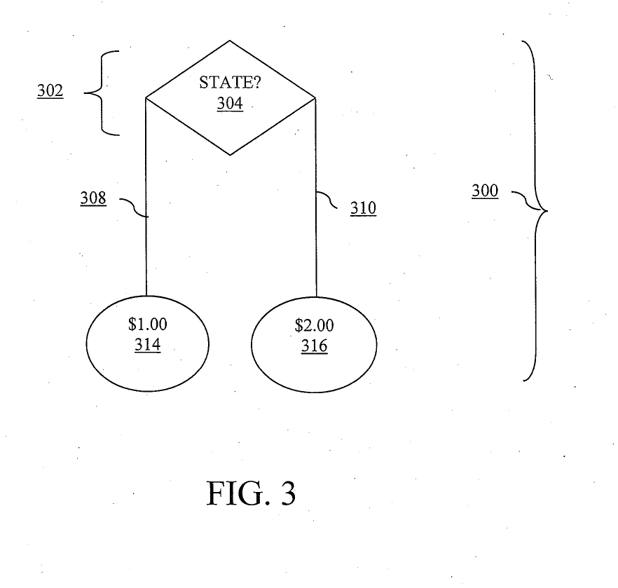

Referring to FIG. 3, a diagram illustrates a premium rule hierarchical target node structure in accordance with one or more embodiments. As illustrated, in some embodiments premium rules may be formed as decision trees associated with a single target dimension (referred to herein as basic premium rules). As illustrated here, hierarchical target node structure 300 may include a target dimension 302. For example, target dimension 302 may refer to an end user location. Here a decision node 304 may be associated with two outcomes, illustrated here as either the state of California at node 308 or the state of New York at node 310, and/or the like. In cases where an additional premium rule 216 (FIG. 2) is identified as being associated with hierarchical node structures 200 (See FIG. 2), a decision path through an associated a hierarchical target node structure 300 to a given premium markup 314/316 may be identified based at least in part on comparing a current context associated with a given end user to such a target dimension. As illustrated, such basic premium rules represented a hierarchical target node structure 300 may be described as follows:

(target_dimension_ID, { (target_min_value, [ target_max_value,]
premium_value) } ),

where “target_dimension_ID” refers to a target dimension, “target_min_value” refers to a minimum target value, “target_max_value” refers to a maximum target value, and “premium_value” refers to a monetary-value-type and/or a percentage-type premium markup. In the above example, such a maximum target value may be optional. As discussed above, for a given request for advertisement, an associated current context may be modeled as a map of a given target dimension and given target value. Likewise, for a given premium rule, an associated target dimension may be modeled as a map of a given target dimension and given target value. As illustrated, such a hierarchical target node structure 300 may be described as follows:
(geo::State, {(“CA”, 1), (“NY”, 2)})
   where “geo::State” refers to a target dimension of a state-type user location, “CA” refers to a target value of the state of California associated with a monetary-value-type premium markup of one dollar, and “NY” refers to a target value of the state of New York associated with a monetary-value-type premium markup of two dollars.

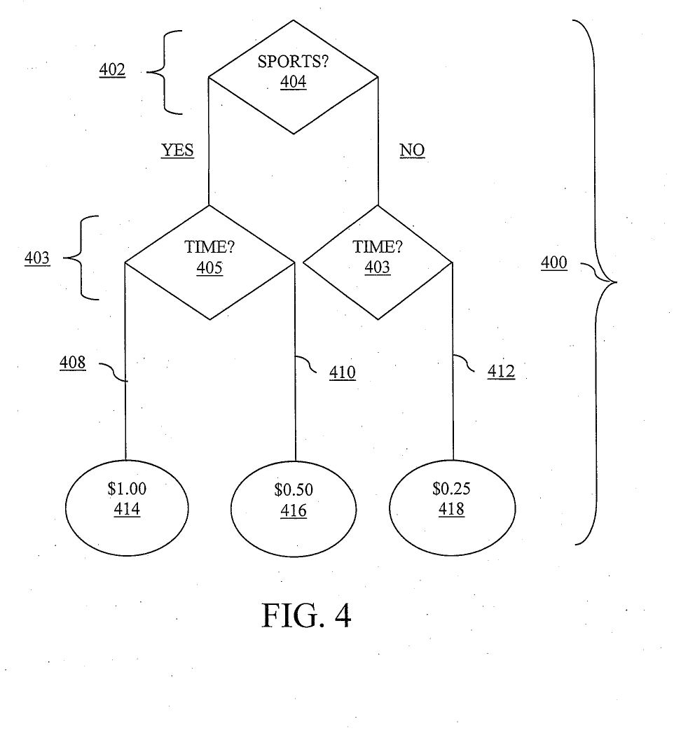

Referring to FIG. 4, a diagram illustrates a premium rule hierarchical target node structure in accordance with one or more embodiments. As illustrated, in some embodiments premium rules may be formed as decision trees associated with two or more target dimensions (referred to herein as composite premium rules). A hierarchical target node structure 400 may be similar in form to a first hierarchical target node structure 300, but may contain a different and/or more complex organization of target dimensions. As illustrated, a given premium rule 216 (FIG. 2) may include a second hierarchical target node structure 400 including two or more target dimensions 402/403. For example, target dimension 402 may include end user interest (e.g. sports), while target dimension 403 may include end user time, and/or the like. Here a decision node 404 may be associated with two outcomes. For example, decision node 404 may be associated with either a “no” result that continues hierarchical target node structure 400 to a second decision node 406, or a “yes” result that continues hierarchical target node structure 400 to a second decision node 405, and/or the like, for example. Such a second decision node 403 may be associated with one or more outcomes. For example, decision node 406 may be associated with a 9 AM-5 PM result associated with a premium markup. Similarly, decision node 405 may be associated with one or more outcomes. For example, decision node 405 may be associated with either an 11 AM-12:59 PM result or a 1 PM-4:59 PM result. Accordingly, such a hierarchical target node structure 400 may be designed so that one or more target nodes 405/406 may be associated with a first target dimension 402 and one or more nodes 408/410 may be associated with a second target dimension 403. In some cases, for simplicity, such first and second target dimensions 402/403 may be restrained so that a comparison of a current context associated with an end user to such two or more target dimensions 402/403 may match no more than one target node 405/406 associated with first target dimension 402 and no more than one target node 408/410/412 associated with second target dimension 403. For example, in the illustration, second target dimension 403 may be restrained so that no more than one target node 408/410 (11 AM-12:59 PM/1 PM-4:59 PM) associated with a time target dimension 403 can match any given time of a given current context. In such a situation, only a single premium markup 414/416/418 may result from comparing a current context associated with a given end user to such target dimensions. Once a premium rule 216 (FIG. 2) is identified as being associated with hierarchical node structures 200 (See FIG. 2), a decision path through premium rules 216 (FIG. 2) to a given premium markup 414/416/418 may be identified based at least in part on comparing a current context associated with a given end user to such two or more target dimensions.

As illustrated, such composite premium rules represented in a hierarchical target node structure 400 may be described as follows:

(target_dimension_ID, { (target_min_value, [ target_max_value,]
premium_rule) } )

where “target_dimension_ID” refers to a target dimension, “target_min_value” refers to a minimum target value, “target_max_value” refers to a maximum target value, and “premium_rule” refers to an additional embedded rule. As illustrated, such a hierarchical target node structure 400 may be described as follows:

(interests::Sports, { (0, (time:: localTime, { (“9am”, “5pm”, 0.25)}),
(1, (time::localTime, { (“11am”, “12:59pm”, 1), (“1pm”, “4:59pm”,
2)})} )

where “interests::Sports” refers to a target dimension of an end user interest (e.g. sports) associated with negative minimum target value of zero and a positive maximum target value of one. With a negative minimum target value of zero, “time::localTime” refers to a second target dimension of an end user time where “9 am-5 pm” refers to a target value of time associated with a monetary-value-type premium markup of twenty five cents. Similarly, with a positive maximum target value of one, “time:: localTime” refers to a second target dimension of an end user time where (“11 am”, “12:59 pm”) refers to a target value range of time associated with a monetary-value-type premium markup of one dollar and where (“1 pm”, “4:59 pm”) refers to a target value range of time associated with a monetary-value-type premium markup of two dollars.

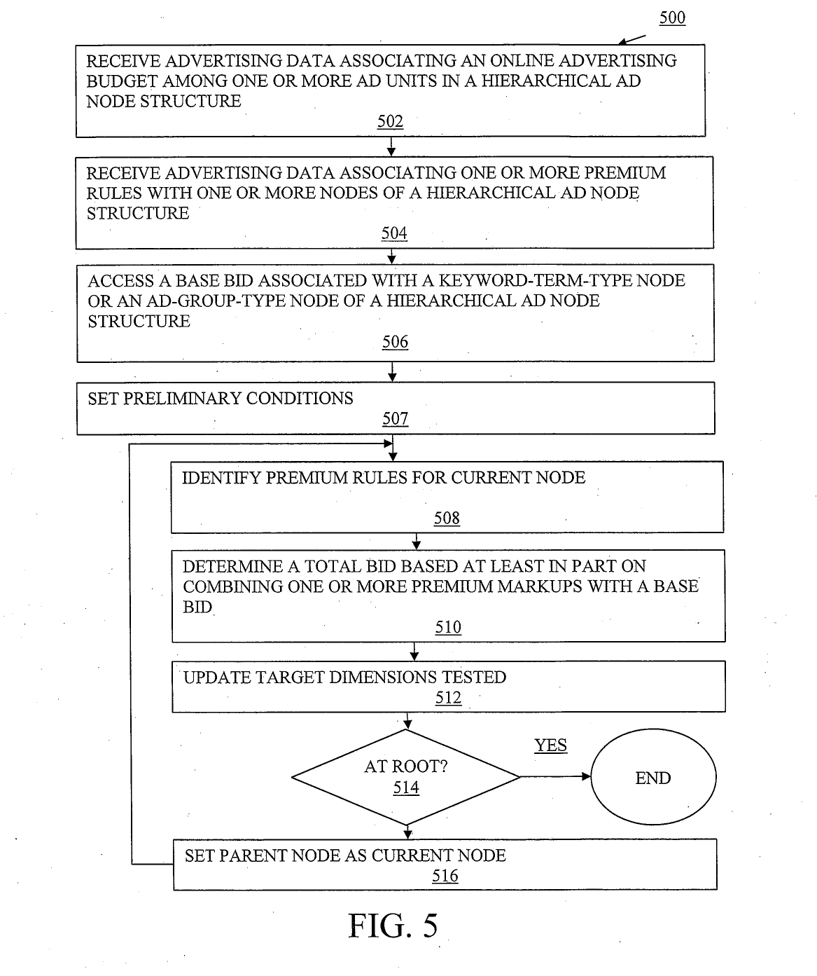

Referring back to FIGS. 2-4, in operation, base bid data may be established based on a bid associated with a keyword term via an ad-group-type node 206 and/or a keyword-term-type node 208. A monetary-value-type and/or a percentage-type premium markup may be set to a zero value. Individual premium rules 216 may be identified climbing up a hierarchical node structure 200 from an ad-group-type node 206 and/or a keyword-term-type node 208. Once a premium rule 216 is identified, a decision path through premium rules 216 to a given premium markup 414/416/418 may be identified based at least in part on comparing a current context associated with a given end user to two or more target dimensions. Multiple premium rules 216 may identified by climbing up hierarchical node structure 200. Such multiple premium rules 216 may factor into the determination of premium markup data associated with a given base bid data. A total bid may be determined based at least in part on premium markup data and base bid data (e.g., one or more premium markups may be combined in some manner with base bid data). For example, such a total bid may be utilized to sort various ad units according to a combined total of both a baseline price associated with a given ad unit and/or a markup price associated with such an ad unit. Additionally, in situations where there is not an applicable premium markup, such a total bid may be based only on base bid data. Additional details regarding such operation may be found below with reference to FIG. 5.

Referring back to FIG. 7, one or more premium rules 216 may be associated with one or more nodes 202/204/206 of hierarchical node structure 200. For example, premium rules 216 may be associated at one or more levels hierarchical node structure 200 (e.g., account-type node 202, campaign-type node 204 and/or ad-group-type node 206). As discussed above, individual premium rules 216 may be identified and/or evaluated in a bottom-up order climbing up hierarchical node structure 200, such as starting at an ad-group-type node 206 and/or a keyword-term-type node 208, for example. Multiple premium rules 216 may identified by climbing up hierarchical node structure 200. Potential conflicts between such multiple premium rules 216 and/or potential conflicts multi-level association of premium rules 216 may be resolved by providing one or more conflict resolution features for premium rules 216. One such conflict resolution feature may include forbidding a group of two or more premium rules 216 from reusing identical target dimension sets. Such a group of two or more premium rules 216 may include those premium rules 216 identified and/or evaluated climbing up hierarchical node structure 200, for example. Such target dimensions from identified and/or evaluated premium rules 216 may be remembered. Precedence may be given to premium rules 216 in the order that such premium rules 216 were identified and/or evaluated, such as in a bottom-up order climbing up hierarchical node structure 200, for example. For example, for a premium rule 216 that has been evaluated to be relevant to a given current context, an associated target dimension set may be remembered. A subsequently identified and/or evaluated premium rule 216 may be ignored. For example, a first premium rule 216 may be associated with a target dimension set of user-time-type time and sports-type interest, and a second premium rule 216 may be ignored in cases where the second premium rule 216 is associated with an identical target dimension set of user-time-type time and sports-type interest.

Process 500, as illustrated in FIG. 5, may utilize one or more premium rules to associate a premium markup to base bid data for online advertising in accordance with one or more embodiments, for example, although the scope of claimed subject matter is not limited in this respect. Additionally, although process 500, as shown in FIG. 5, comprises one particular order of blocks, the order in which the blocks are presented does not necessarily limit claimed subject matter to any particular order. Likewise, intervening blocks shown in FIG. 5 and/or additional blocks not shown in FIG. 5 may be employed and/or blocks shown in FIG. 5 may be eliminated, without departing from the scope of claimed subject matter.

Process 500, depicted in FIG. 5, may in alternative embodiments be implemented in software, hardware, and/or firmware, and may comprise discrete operations. As illustrated, process 500 may utilize one or more premium rules to associate a premium markup to base bid data for online advertising. Starting at block 502, advertising data may be received, where such advertising data may associate an online advertising budget among one or more ad units in a hierarchical node structure. Such an online advertising budget may comprise prices associated with one or more ad units. As discussed above, each ad unit may comprise a keyword term and a creative component.

At block 504, advertising data may be received, where such advertising data may associate one or more premium rules with one or more nodes of such a hierarchical node structure. As discussed above, such premium rules may include a hierarchical target node structure including two or more target dimensions. For example, two or more premium rules may be associated to an ad unit at one or more of the following hierarchical nodes: an account-type node, a campaign-type node, and/or an ad-group-type node and/or the like. To avoid potential conflict among premium rules, a group of two or more premium rules 216 may be forbidden from reusing identical target dimension sets.

For a premium rule, its hierarchical target node structure may include one or more target nodes associated with a first target dimension and one or more nodes associated with a second target dimension. For example, such a first and second target dimensions may be restrained so that a comparison of a current context to such two or more target dimensions may match no more than one target node associated with a first target dimension and no more than one target node associated with a second target dimension.

At block 506, base bid data associated with a node of such a hierarchical ad node structure may be accessed. As discussed above, such a node may be associated with at least a portion of an ad unit. For example, such a node may include a keyword-term-type node associated with a keyword term portion of an ad unit. Additionally or alternatively, such a node may include an ad-group-type node associated with an ad unit. As discussed above, such target dimensions may include one or more of the following: an end user demographic, end user location, time, end user interests, publication content, publication Uniform Resource Locator (URL), publication domain, publication site, and/or the like, and/or combinations thereof.

At block 507, preliminary conditions may be set. For example, an initial total bid may be set as equal to an accessed base bid value. Additionally, a current node of the hierarchical ad node structure may be specified. For example, such a current node may be specified as a keyword-term-type node associated with a keyword term portion of an ad unit. Further, a set of tested target dimensions may be reset.

At block 508, a subset of premium rules associated with such a current node may be identified. As discussed above, potential conflicts between multiple premium rules and/or potential conflicts multi-level association of premium rules may be resolved by providing one or more conflict resolution features for premium rules. One such conflict resolution feature may include forbidding a group of two or more premium rules from reusing identical target dimension sets. Such a group of two or more premium rules may include those premium rules identified and/or evaluated climbing up a hierarchical node structure, for example. Such target dimensions from identified and/or evaluated premium rules may be remembered. Precedence may be given to premium rules in the order that such premium rules were identified and/or evaluated, such as in a bottom-up order climbing up a hierarchical node structure, for example. For example, for a premium rule that has been evaluated to be relevant to a given current context, an associated target dimension set may be remembered. A subsequently identified premium rule may be ignored.

Accordingly, a premium markup data may be determined based at least in part on such identified premium rules. For example such premium markup data may be determined based at least in part on one or more premium rules comparing a current context associated with a given end user to two or more target dimensions. For example, such premium markup data may be based at least in part on a percentage-type premium markup, such as a percentage of base bid data. Alternatively, such premium markup data may be based at least in part on monetary values independent of base bid data. As discussed above, such current contexts may include an end user demographic, end user location, time, end user interests, publication content, publication Uniform Resource Locator (URL), publication domain, publication site, and/or the like, and/or combinations thereof.

At block 510, a total bid may, for example, be determined based at least in part on combining premium markup data with base bid data. In some cases, such base bid data may be represented by an initial total bid that was set to be equal to a base bid at block 507, for example. Additionally, in situations where there is not applicable premium markup, such a total bid may be based only on base bid data. Such a total bid may be utilized to charge an advertiser for delivering a given ad to an end user.

At block 512, a set of tested target dimensions may be updated. For example, a set of tested target dimensions may be updated to included those dimensions tested at block 508.

At block 514, a determination may be made to see if process 500 has reached a root of the hierarchical ad node structure. In cases where such a root has been reached, process 500 may end. In cases where such a root has not been reached, a parent node may be set to be the current node to be analyzed and process 500 may return to block 508 for further operations, as illustrated at block 516,

In operation, process 500 may be utilized to provide a flexible and structured mechanism for advertisers (and/or other like entities) to control premium markups associated with a targeting of certain publishers, pages and/or end users. For example, the mechanism, illustrated by process 500, may allow for a flexible and extensive taxonomy for target dimensions include various combinations of the following: an end user demographic, end user location, time, end user interests, publication content, publication Uniform Resource Locator (URL), publication domain, publication site, and/or the like, and/or combinations thereof. For example, in some embodiments, premium rules may be formed as decision trees associated with a single target dimension (referred to herein as basic premium rules) and/or as decision trees associated with two or more target dimensions (referred to herein as composite premium rules). Additionally, multi-level association of premium rules 216 with hierarchical node structure 200 may be facilitated by providing a conflict resolution between premium rules 216. For example, a group of two or more premium rules 216 may be forbidden from reusing identical target dimension sets. Further, a hierarchical target node structure may include one or more target nodes associated with a first target dimension and one or more nodes associated with a second target dimension. In such a case, such a first and second target dimensions may be restrained so that a comparison of a current context to such two or more target dimensions may match no more than one target node associated with a first target dimension and no more than one target node associated with a second target dimension.

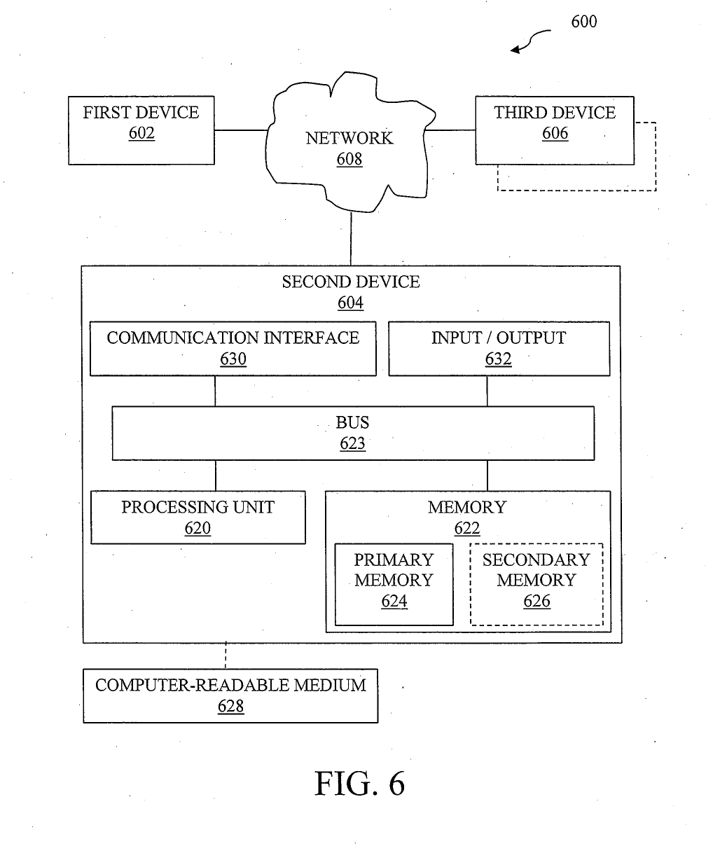

FIG. 6 is a block diagram illustrating an exemplary embodiment of a computing environment system 600 that may include one or more devices configurable to utilize one or more premium rules to associate a premium markup to base bid data for online advertising using one or more techniques illustrated above, for example. For example, computing environment system 600 may be operatively enabled to perform all or a portion of process 500 of FIG. 5.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608. By way of example, but not limitation, any of first device 602, second device 604, or third device 606 may include: one or more computing platforms or devices, such as, e.g., a desktop computer, a laptop computer, a workstation, a server device, storage units, or the like.

Network 608, as shown in FIG. 6, is representative of one or more communication links, processes, and/or resources configurable to support the exchange of data between at least two of first device 602, second device 604 and third device 606. By way of example, but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 606, there may be additional like devices operatively coupled to network 608, for example.

It is recognized that all or part of the various devices and networks shown in system 600, and the processes and methods as further described herein, may be implemented using or otherwise include hardware, firmware, software, or any combination thereof.

Thus, by way of example, but not limitation, second device 604 may include at least one processing unit 620 that is operatively coupled to a memory 622 through a bus 623.

Processing unit 620 is representative of one or more circuits configurable to perform at least a portion of a data computing procedure or process. By way of example, but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example, but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 632 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

In one implementation, premium rules may associate premium markup data to base bid data for online advertising via a computing platform. Such premium ruling may be performed via a computing platform that manipulates or transforms electronic signals employed to represent physical electronic or magnetic quantities, or other physical quantities, within the computing platform's memories, registers, or other information storage, transmission, or display devices. For example, a computing platform may be enabled to receive advertising data that associates an online advertising budget among one or more ad units in a hierarchical node structure represented within one or more computing platforms by digital electronic signals. Such a computing platform may additionally be enabled to receive advertising data that associates one or more premium rules represented within such computing platforms by digital electronic signals with one or more nodes of such a hierarchical node structure. Such a computing platform may additionally be enabled to access base bid data represented within such computing platforms by digital electronic signals associated with a node of such a hierarchical node structure. Such a computing platform may additionally be enabled to determine premium markup data represented within such computing platforms by digital electronic signals based at least in part on a comparison via such premium rules of a current context associated with a given end user to such target dimensions

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method comprising:
with at least one computing platform:
receiving advertising data associating an online advertising budget among one or more ad units in a hierarchical node structure, wherein at least one ad unit comprises a keyword term and a creative component;
receiving advertising data associating one or more premium rules with one or more nodes of said hierarchical node structure, wherein said one or more premium rules comprise a hierarchical target node structure comprising two or more target dimensions;
accessing base bid data associated with a node of said hierarchical node structure, wherein said node is associated with at least a portion of said at least one ad unit; and
determining premium markup data based at least in part on said one or more premium rules comparing a current context associated with a given end user to said two or more target dimensions.

2. The method of claim 1, wherein said two or more premium rules are associated to said at least one ad unit at one or more of the following hierarchical nodes: an account-type node, a campaign-type node, and/or an ad-group-type node.

3. The method of claim 1, wherein said node comprises a keyword-term-type node associated with a keyword term portion of said at least one ad unit.

4. The method of claim 1, wherein said node comprises an ad-group-type node associated with said at least one ad unit.

5. The method of claim 1, wherein at least one of said target dimensions is associated with one or more of the following: an end user demographic, end user location, time, end user interests, publication content, publication Uniform Resource Locator (URL), publication domain, and/or publication site.

6. The method of claim 1, wherein said hierarchical target node structure of two or more target dimensions comprises one or more target nodes associated with a first target dimension and one or more nodes associated with a second target dimension, wherein said first and second target dimensions are restrained so that said comparison of a current context to said two or more target dimensions will match no more than one of said one or more target nodes associated with said first target dimension and no more than one of said one or more target nodes associated with said second target dimension.

7. The method of claim 1, wherein said premium markup data is based at least in part on a percentage of said base bid data.

8. The method of claim 1, further comprising preventing a group of two or more premium rules from reusing identical target dimension sets, wherein one or more of said target dimensions comprise a target dimension portion.

9. The method of claim 1, further comprising determining total bid data based at least in part on said premium markup data and said base bid data.

10. The method of claim 1, further comprising:
determining total bid data based at least in part on said premium markup data and said base bid data;
wherein said two or more premium rules are associated with said at least one ad unit at one or more of the following hierarchical nodes: an account-type node, a campaign-type node, and/or an ad-group-type node;
wherein said target dimensions are associated with one or more of the following: an end user demographic, end user location, time, end user interests, publication content, publication Uniform Resource Locator (URL), publication domain, and/or publication site;
preventing a group of two or more premium rules from reusing identical target dimension sets, wherein one or more of said target dimensions comprise a target dimension portion; and
wherein said hierarchical target node structure of two or more target dimensions comprises one or more target nodes associated with a first target dimension and one or more nodes associated with a second target dimension, wherein said first and second target dimensions are restrained so that said comparison of a current context to said two or more target dimensions will match no more than one of said one or more target nodes associated with said first target dimension and no more than one of said one or more target nodes associated with said second target dimension.

11. An article comprising:
a storage medium comprising machine-readable instructions stored thereon, which, if executed by one or more processing units, operatively enable a computing platform to:
receive advertising data that associates an online advertising budget among one or more ad units in a hierarchical node structure, wherein at least one ad unit comprises a keyword term and a creative component;
receive advertising data that associates one or more premium rules with one or more nodes of said hierarchical node structure, wherein said one or more premium rules comprise a hierarchical target node structure comprising two or more target dimensions;
access base bid data associated with a node of said hierarchical node structure, wherein said leaf node is associated with at least a portion of at least one of said ad units; and
determine premium markup data based at least in part on a comparison via said one or more premium rules of a current context associated with a given end user to said two or more target dimensions.

12. The article of claim 11, wherein said two or more premium rules are associated to said at least one of said ad units at one or more of the following hierarchical nodes: an account-type node, a campaign-type node, and/or an ad-group-type node.

13. The article of claim 11, wherein at least one of said target dimensions is associated with one or more of the following: an end user demographic, end user location, time, end user interests, publication content, publication Uniform Resource Locator (URL), publication domain, and/or publication site.

14. The article of claim 11, wherein said hierarchical target node structure of two or more target dimensions comprises one or more target nodes associated with a first target dimension and one or more nodes associated with a second target dimension, wherein said first and second target dimensions are restrained so that said comparison of a current context to said two or more target dimensions will match no more than one of said one or more target nodes associated with said first target dimension and no more than one of said one or more target nodes associated with said second target dimension.

15. The article of claim 11, wherein said machine-readable instructions, if executed by the one or more processing units, operatively enable the computing platform to:
determine total bid data based at least in part on said premium markup data with said base bid data.

16. An apparatus comprising:
a computing platform, said computing platform being operatively enabled to:
receive advertising data that associates an online advertising budget among one or more ad units in a hierarchical node structure, wherein at least one ad unit comprises a keyword term and a creative component;
receive advertising data that associates one or more premium rules with one or more nodes of said hierarchical node structure, wherein said one or more premium rules comprise a hierarchical target node structure comprising two or more target dimensions;
access base bid data associated with a node of said hierarchical node structure, wherein said node is associated with at least a portion of at least one of said ad units; and
determine premium markup data based at least in part on a comparison via said one or more premium rules of a current context associated with a given end user to said two or more target dimensions.

17. The apparatus of claim 16, wherein said two or more premium rules are associated to said at least one of said ad units at one or more of the following hierarchical nodes: an account-type node, a campaign-type node, and/or an ad-group-type node.

18. The apparatus of claim 16, wherein said target dimensions are associated with one or more of the following: an end user demographic, end user location, time, end user interests, publication content, publication Uniform Resource Locator (URL), publication domain, and/or publication site.

19. The apparatus of claim 16, wherein said hierarchical target node structure of two or more target dimensions comprises one or more target nodes associated with a first target dimension and one or more nodes associated with a second target dimension, wherein said first and second target dimensions are restrained so that said comparison of a current context to said two or more target dimensions will match no more than one of said one or more target nodes associated with said first target dimension and no more than one of said one or more target nodes associated with said second target dimension.

20. The apparatus of claim 16, wherein said machine-readable instructions, if executed by a computing platform, further direct a computing platform to determine total bid data based at least in part on said premium markup data and said base bid data.
